(19) United States
(12) Patent Application Publication
(10) Pub. No.: US 2011/0177402 A1
(43) Pub. Date: Jul. 21, 2011

(54) EXCESS HYDROGEN CONSUMPTION UNIT, FUEL CELL UNIT AND FUEL CELL SYSTEM

(75) Inventors: Yueh-Chang Wu, Hsinchu County (TW); Cheng Wang, Hsinchu County (TW); Po-Kuei Chou, Hsinchu County (TW)

(73) Assignee: YOUNG GREEN ENERGY CO., HSINCHU COUNTY (TW)

(21) Appl. No.: 12/915,022

(22) Filed: Oct. 29, 2010

(30) Foreign Application Priority Data
Jan. 15, 2010 (CN) 201010002983.4

(51) Int. Cl. H01M 8/06

(52) U.S. Cl. 429/408

(57) ABSTRACT

A fuel cell unit includes a proton exchange membrane, a first catalyst layer, a second catalyst layer, a first gas diffusion layer (GDL) disposed on the first catalyst layer, a second GDL disposed on the second catalyst layer, a flow channel of hydrogen gas disposed on the first GDL for guiding a hydrogen gas to the first GDL, and a flow channel of excess hydrogen gas disposed on the second GDL and communicated with the channel of hydrogen gas. The first and the second catalyst layers are respectively disposed at both sides of the proton exchange membrane. The hydrogen gas in the flow channel of excess hydrogen gas and an oxygen gas outside the flow channel of excess hydrogen gas are capable of mixing with each other in the second GDL and contacting the second catalyst layer to generate a chemical combustion reaction.

### CROSS-REFERENCE TO RELATED APPLICATION

This application claims the priority benefit of China application serial no. 201010002983.4, filed on Jan. 15, 2010. The entirety of the above-mentioned patent application is hereby incorporated by reference herein and made a part of this specification.

### BACKGROUND OF THE INVENTION

1. Field of the Invention

The invention generally relates to a fuel cell, and more particularly, to a fuel cell able to consume excess hydrogen gas.

2. Description of Related Art

Basically, a fuel cell is a power generator that converts chemical energy into electrical energy by utilizing the reverse reaction of the water electrolysis. In terms of a proton exchange membrane fuel cell (PEMFC), the PEMFC mainly includes a membrane electrode assembly (MEA) and a flow channel of hydrogen gas for supplying hydrogen gas (H₂) to the MEA.

The MEA includes a proton exchange membrane, an anode catalyst layer, a cathode catalyst layer, an anode gas diffusion layer (anode GDL), and a cathode gas diffusion layer (cathode GDL). The anode catalyst layer and the cathode catalyst layer are respectively disposed at both sides of the proton exchange membrane, and the anode GDL and the cathode GDL are respectively disposed at the outer sides of the anode catalyst layer and the cathode catalyst layer, wherein both the outer sides are opposite to the proton exchange membrane.

The flow channel of hydrogen gas guides hydrogen gas (H₂) to the anode GDL, while the hydrogen gas (H₂) going through the anode GDL reacts at the anode catalyst layer to generate hydrogen ions (H⁺) and electrons (e⁻). After that, the hydrogen ions (H⁺) go through the proton exchange membrane, followed by reacting at the cathode catalyst layer with the electrons (e⁻) and oxygen gas (O₂) going through the cathode GDL, so as to generate water (H₂O).

The hydrogen gas is generated through the reaction of solid sodium borohydride (NaBH₄) and water. Therefore, the chemical reaction is a one-off reaction, i.e., the hydrogen gas are durably generated until the chemical reaction of the solid sodium borohydride (NaBH₄) and the water (H₂O) is finished. In this regard, when the MEA is unable to entirely consume the excess hydrogen gas, the excess non-reacted hydrogen gas would be accumulated at the fuel cell. As a result, once the concentration of the hydrogen gas gets excessively high, a safety concern with operating the fuel cell becomes a great issue.

### SUMMARY OF THE INVENTION

Accordingly, the invention is directed to an excess hydrogen consumption unit for consuming the excess hydrogen gas from a fuel cell unit.

The invention is also directed to a fuel cell unit for consuming the excess hydrogen gas.

The invention is further directed to a fuel cell system for consuming the excess hydrogen gas.

Other advantages of the invention should be further indicated by the disclosures of the invention, and omitted herein for simplicity.

To achieve one of, a part of or all of the above-mentioned advantages, or to achieve other advantages, the invention provides an excess hydrogen consumption unit adapted to consume an excess hydrogen gas discharged from a flow channel of hydrogen gas of a fuel cell unit. The excess hydrogen consumption unit includes a catalyst layer, a gas diffusion layer (GDL), and a flow channel of excess hydrogen gas. The GDL is disposed on the catalyst layer and the flow channel of excess hydrogen gas is disposed on the GDL and adapted to be communicated with the flow channel of hydrogen gas, wherein a hydrogen gas in the flow channel of excess hydrogen gas and an oxygen gas outside the flow channel of excess hydrogen gas are capable of mixing with each other in the GDL and contacting the catalyst layer to generate a chemical combustion reaction.

To achieve one of, a part of or all of the above-mentioned advantages, or to achieve other advantages, the invention provides a fuel cell unit, which includes a proton exchange membrane, a first catalyst layer, a second catalyst layer, a first GDL, a second GDL, a flow channel of hydrogen gas, and a flow channel of excess hydrogen gas. The second catalyst layer and the first catalyst layer are respectively disposed at both sides of the proton exchange membrane. The first GDL is disposed on the first catalyst layer, the second GDL is disposed on the second catalyst layer, the flow channel of hydrogen gas is disposed on the first GDL for guiding a hydrogen gas to the first GDL, and the flow channel of excess hydrogen gas is disposed on the second GDL and communicated with the flow channel of hydrogen gas. The hydrogen gas in the flow channel of excess hydrogen gas and an oxygen gas outside the flow channel of excess hydrogen gas are capable of mixing with each other in the second GDL and contacting the second catalyst layer to generate a chemical combustion reaction.

To achieve one of, a part of or all of the above-mentioned advantages, or to achieve other advantages, the invention provides a fuel cell system, which includes a hydrogen gas supply unit and a fuel cell unit. The fuel cell unit includes a proton exchange membrane, a first catalyst layer, a second catalyst layer, a first GDL, a second GDL, a flow channel of hydrogen gas, and a flow channel of excess hydrogen gas. The second catalyst layer and the first catalyst layer are respectively disposed at both sides of the proton exchange membrane. The first GDL is disposed on the first catalyst layer, the second GDL is disposed on the second catalyst layer, the flow channel of hydrogen gas is disposed on the first GDL for guiding the hydrogen gas supplied by the hydrogen gas supply unit to the first GDL, and the flow channel of excess hydrogen gas is disposed on the second GDL and communicated with the flow channel of hydrogen gas. A hydrogen gas in the flow channel of excess hydrogen gas and oxygen gas outside the flow channel of excess hydrogen gas are capable of mixing with each other in the second GDL and contacting the second catalyst layer to generate a chemical combustion reaction.

Based on the depiction above, the above-mentioned embodiments of the invention have at least one of the following advantages. The excess hydrogen consumption unit is able to consume the excess hydrogen gas discharged from the fuel cell so as to avoid the potential safety problem of the fuel cell unit caused by the excess hydrogen gas. In addition, the fuel cell unit guides the excess hydrogen gas at the anode to the flow channel of excess hydrogen gas at the cathode, and the excess hydrogen gas may mix with the oxygen gas through the GDL at the cathode and the catalyst layer, so as to generate a chemical combustion reaction to consume the excess hydrogen gas.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a fuel cell unit and an excess hydrogen consumption unit according to an embodiment of the invention.

FIG. 2 is a sectional structure diagram of the excess hydrogen consumption unit in FIG. 1.

FIG. 3 is a sectional structure diagram of an excess hydrogen consumption unit according to another embodiment of the invention.

FIG. 4 is a block diagram of a fuel cell system according to another embodiment of the invention.

FIG. 5 is a block diagram of a fuel cell unit in FIG. 4.

FIG. 6 is a three-dimensional diagram with localized sections of the fuel cell unit in FIG. 5.

FIG. 7 is a sectional structure diagram of the fuel cell unit of FIG. 5.

FIG. 8 is a sectional structure diagram of a fuel cell unit according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

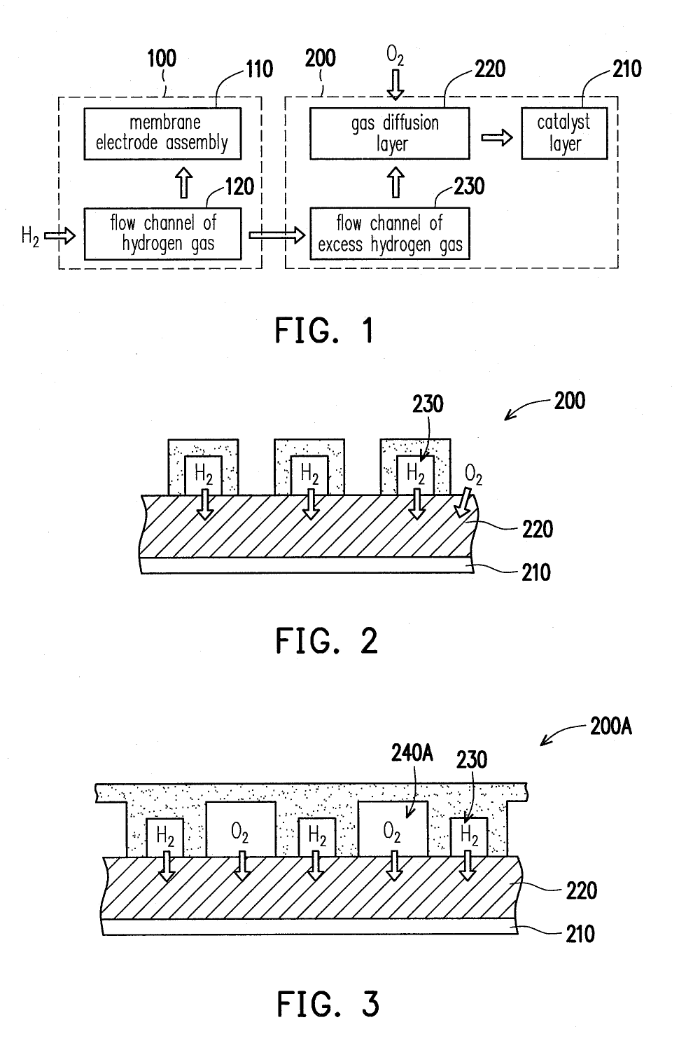

FIG. 1 is a block diagram of a fuel cell unit and an excess hydrogen consumption unit according to an embodiment of the invention and FIG. 2 is a sectional structure diagram of the excess hydrogen consumption unit in FIG. 1. Referring to FIGS. 1 and 2, in the embodiment, the fuel cell unit 100 includes an MEA 110 and a flow channel of hydrogen gas 120, wherein the flow channel of hydrogen gas 120 is for guiding the hydrogen gas to the MEA 110 to supply the fuel required by the MEA 110 during reactions.

When the amount of the supplied hydrogen gas is greater than the amount of the hydrogen gas required by the electrochemistry reaction, the excess hydrogen gas would be guided to an excess hydrogen consumption unit 200. In the embodiment, the excess hydrogen consumption unit 200 includes a catalyst layer 210, a GDL 220 disposed on the catalyst layer 210 and a flow channel of excess hydrogen gas 230 disposed on the GDL 220. The GDL 220 is, for example, carbon cloth, carbon paper or conductive porous materials, and the catalyst layer 210 may be a layer of platinum or other catalysts distributed on the GDL 220.

When the excess hydrogen gas output from the fuel cell unit 100 is guided to the flow channel of excess hydrogen gas 230, the hydrogen gas in the flow channel of excess hydrogen gas 230 and the oxygen gas outside the flow channel of excess hydrogen gas 230 may diffuse towards the GDL 220 and mix with each other in GDL 220. Once the mixed hydrogen gas and the oxygen gas contact the catalyst layer 210, the chemical combustion reaction is generated to produce water and heat.

In this way, the excess hydrogen gas output from the fuel cell unit 100 would be consumed by the excess hydrogen consumption unit 200, which avoids the potential safety problem of the fuel cell unit caused by the excess hydrogen gas. In the embodiment, the portion of the GDL 220 unshielded by the flow channel of excess hydrogen gas 230 is exposed to the air, so that the oxygen gas in the air may diffuse into the GDL 220 and mix with the excess hydrogen gas.

In the embodiment, a plurality of branches of the flow channel of excess hydrogen gas 230 make the excess hydrogen gas disperse over the whole surface of the GDL 220, which may disperse the heat produced during the chemical combustion reaction of the excess hydrogen gas and the oxygen gas in the catalyst layer 210.

FIG. 3 is a sectional structure diagram of an excess hydrogen consumption unit according to another embodiment of the invention. Differently from the embodiment of FIG. 2, an excess hydrogen consumption unit 200A herein further includes a flow channel of oxygen gas 240A disposed on the GDL 220 for guiding the oxygen gas to the GDL 220. It should be noted that the flow channel of oxygen gas 240A and the flow channel of excess hydrogen gas 230 are separated from each other, so that the excess hydrogen gas and the oxygen gas are respectively guided into the GDL 220 for mixing.

In the embodiment, by using the branches of the flow channel of excess hydrogen gas 230 and a plurality of branches of the flow channel of oxygen gas 240A, the excess hydrogen gas and the oxygen gas are able to disperse over the whole surface of the GDL 220, which may disperse the heat produced during the chemical combustion reaction of the excess hydrogen gas and the oxygen gas in the catalyst layer 210.

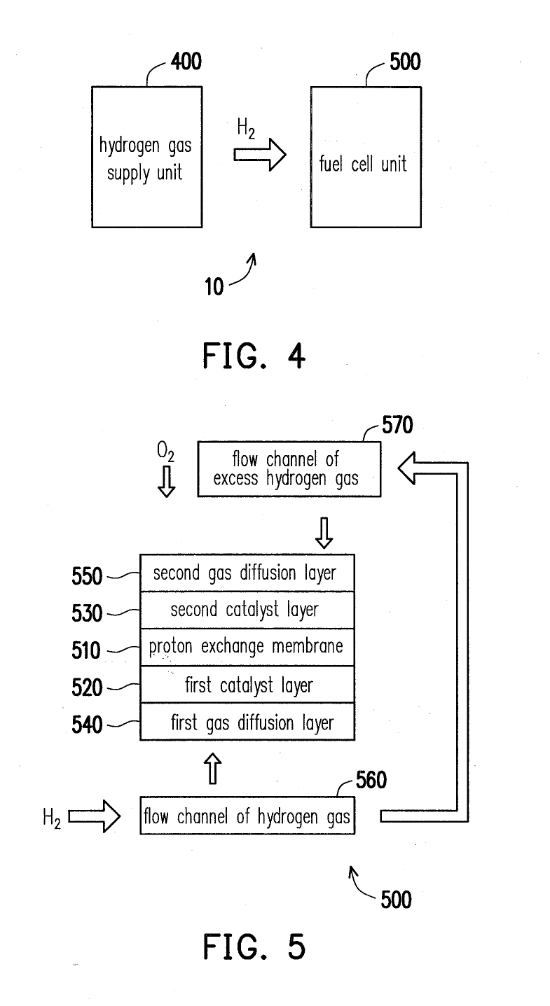

FIG. 4 is a block diagram of a fuel cell system according to another embodiment of the invention and FIG. 5 is a block diagram of a fuel cell unit in FIG. 4. Referring to FIGS. 4 and 5, in the embodiment, the fuel cell system 10 includes a hydrogen gas supply unit 400 and a fuel cell unit 500. The hydrogen gas supply unit 400 makes the solid sodium borohydride and the water cause a chemical reaction, so as to generate the hydrogen gas, which the invention is not limited to. The fuel cell unit 500 includes a proton exchange membrane 510, a first catalyst layer 520, a second catalyst layer 530, a first GDL 540, a second GDL 550, and a flow channel of hydrogen gas 560.

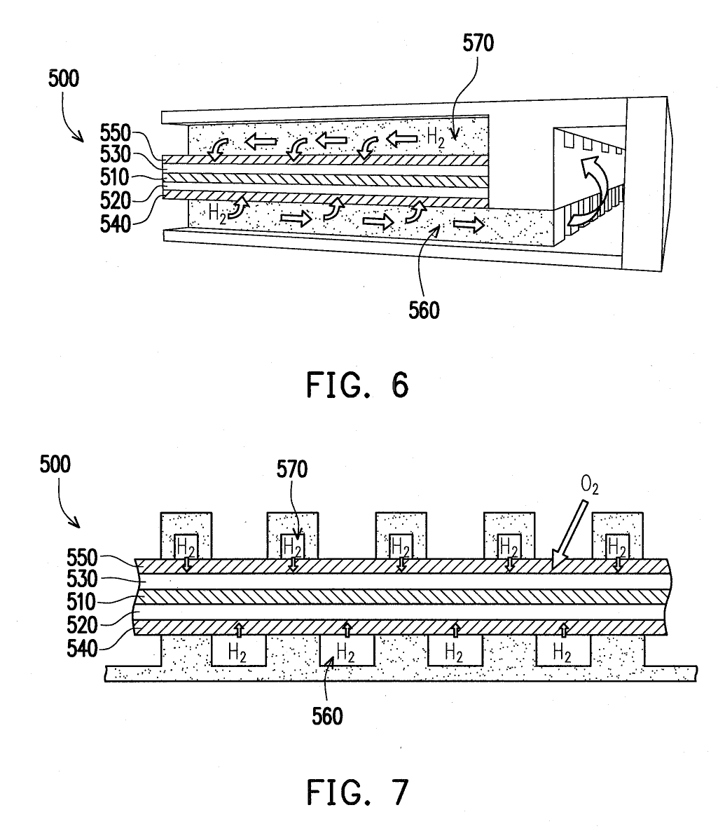

FIG. 6 is a three-dimensional diagram with localized sections of the fuel cell unit in FIG. 5 and FIG. 7 is a sectional structure diagram of the fuel cell unit of FIG. 5. Referring to FIGS. 6 and 7, the second catalyst layer 530 and the first catalyst layer 520 are respectively disposed at both sides of the proton exchange membrane 510. The first GDL 540 is disposed on the first catalyst layer 520, and the second GDL 550 is disposed on the second catalyst layer 530. The flow channel of hydrogen gas 560 is disposed on the first GDL 540 for guiding the hydrogen gas supplied by the hydrogen gas supply unit 400 to the first GDL 540.

By using the flow channel of hydrogen gas 560 to guide the hydrogen gas (H₂) to the first GDL 540, the hydrogen gas after going through the first GDL 540 reacts with the first catalyst layer 520 to generate hydrogen ions (H⁺) and electrons (e⁻). After that, the hydrogen ions (H⁺) go through the proton exchange membrane 510, followed by reacting on the second catalyst layer 530 with the electrons (e⁻) and the oxygen gas (O₂) going through the second GDL 550 to produce water (H₂O).

In order to consume the excess hydrogen gas, the fuel cell unit 500 further includes a flow channel of excess hydrogen gas 570 disposed on the second GDL 550 and communicated with the flow channel of hydrogen gas 560 for guiding the excess hydrogen gas to the second GDL 550. The excess hydrogen gas in the flow channel of excess hydrogen gas 570 and the oxygen gas outside the flow channel of excess hydrogen gas 570 mix with each other in the second GDL 550 and contact the second catalyst layer 530 to generate the chemical combustion reaction to produce water and heat. In this way, the excess hydrogen gas is consumed. In the embodiment, a first extension direction of the flow channel of hydrogen gas 560 and a second extension direction of the flow channel of excess hydrogen gas 570 are parallel to each other. In another embodiment, a first extension direction of the flow channel of hydrogen gas 560 and a second extension direction of the flow channel of excess hydrogen gas 570 are oblique to each other (not shown).

In the embodiment, the water produced during the chemical combustion reaction of the excess hydrogen gas and the oxygen gas may be used to soak the proton exchange membrane 510 for increasing the motion rate of the protons, which is advantageous in promoting the efficiency of the fuel cell unit 500.

In the embodiment, a plurality of branches of the flow channel of excess hydrogen gas 570 make the excess hydrogen gas disperse over the whole surface of the second GDL 550, which may disperse the heat produced during the chemical combustion reaction of the excess hydrogen gas and the hydrogen gas in the second catalyst layer 530.

In the embodiment, the portion of the second GDL 550 unshielded by the flow channel of excess hydrogen gas 570 is exposed to the air, so that the oxygen gas in the air may diffuse into the second GDL 550 and mix with the excess hydrogen gas.

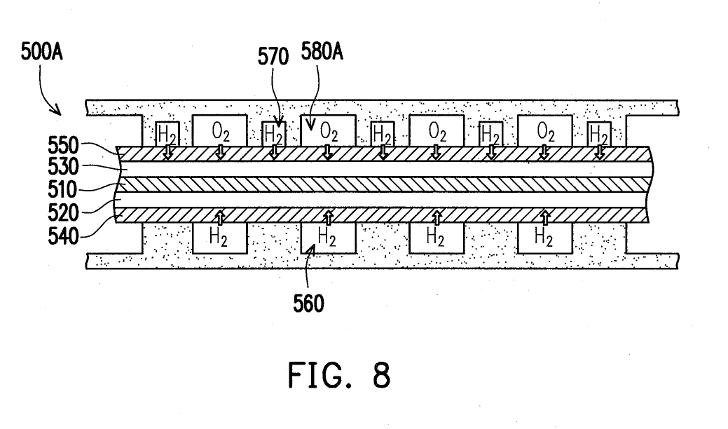

FIG. 8 is a sectional structure diagram of a fuel cell unit according to another embodiment of the invention. Differently from the embodiment of FIG. 7, a fuel cell unit 500A further includes a flow channel of oxygen gas 580A disposed on the second GDL 550 for guiding the oxygen gas to the second GDL 550. It should be noted that the flow channel of oxygen gas 580A and the flow channel of excess hydrogen gas 570 are separated from each other, so that oxygen gas and the excess hydrogen gas may be respectively guided into the second GDL 550 for mixing.

In the embodiment, by using the branches of the flow channel of excess hydrogen gas 570 and a plurality of branches of the flow channel of oxygen gas 580A, the excess hydrogen gas and the oxygen gas are able to disperse over the whole surface of the second GDL 550, which may disperse the heat produced during the chemical combustion reaction of the excess hydrogen gas and the oxygen gas in the second catalyst layer 530.

In summary, the above-mentioned embodiments of the invention have at least one of the following advantages. The excess hydrogen consumption unit is able to consume the excess hydrogen gas discharged from the fuel cell unit so as to avoid the potential safety problem of the fuel cell unit caused by the excess hydrogen gas. In addition, the fuel cell unit may guide the excess hydrogen gas at the anode to the flow channel of excess hydrogen gas at the cathode, and the excess hydrogen gas may mix with the oxygen gas through the GDL at the cathode and the catalyst layer, so as to generate a chemical combustion reaction to consume the excess hydrogen gas.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An excess hydrogen consumption unit, adapted to consume an excess hydrogen gas discharged from a flow channel of hydrogen gas of a fuel cell unit, the excess hydrogen consumption unit comprising:
a catalyst layer;
a gas diffusion layer, disposed on the catalyst layer; and
a flow channel of excess hydrogen gas, disposed on the gas diffusion layer and adapted to be communicated with the flow channel of hydrogen gas, wherein the hydrogen gas in the flow channel of excess hydrogen gas and an oxygen gas outside the flow channel of excess hydrogen gas are capable of mixing with each other in the gas diffusion layer and contacting the catalyst layer to generate a chemical combustion reaction.

2. The excess hydrogen consumption unit as claimed in claim 1, further comprising:
a flow channel of oxygen gas, disposed on the gas diffusion layer for guiding the oxygen gas to the gas diffusion layer, wherein the flow channel of oxygen gas and the flow channel of excess hydrogen gas are separated from each other, and the hydrogen gas in the flow channel of excess hydrogen gas and the oxygen gas in the flow channel of oxygen gas are capable of mixing with each other in the gas diffusion layer.

3. The excess hydrogen consumption unit as claimed in claim 1, wherein a first extension direction of the flow channel of hydrogen gas and a second extension direction of the flow channel of excess hydrogen gas are parallel to each other.

4. The excess hydrogen consumption unit as claimed in claim 1, wherein a first extension direction of the flow channel of hydrogen gas and a second extension direction of the flow channel of excess hydrogen gas are oblique to each other.

5. A fuel cell unit, comprising:
a proton exchange membrane;
a first catalyst layer;
a second catalyst layer, wherein the second catalyst layer and the first catalyst layer are respectively disposed at both sides of the proton exchange membrane;
a first gas diffusion layer, disposed on the first catalyst layer;
a second gas diffusion layer, disposed on the second catalyst layer;
a flow channel of hydrogen gas, disposed on the first gas diffusion layer for guiding a hydrogen gas to the first gas diffusion layer; and
a flow channel of excess hydrogen gas, disposed on the second gas diffusion layer and communicated with the flow channel of hydrogen gas, wherein the hydrogen gas in the flow channel of excess hydrogen gas and an oxygen gas outside the flow channel of excess hydrogen gas are capable of mixing with each other in the second gas diffusion layer and contacting the second catalyst layer to generate a chemical combustion reaction.

6. The fuel cell unit as claimed in claim 5, further comprising:
a flow channel of oxygen gas, disposed on the second gas diffusion layer for guiding the oxygen gas to the second gas diffusion layer, wherein the flow channel of oxygen gas and the flow channel of excess hydrogen gas are separated from each other, and the hydrogen gas in the flow channel of excess hydrogen gas and the oxygen gas in the flow channel of oxygen gas are capable of mixing with each other in the second gas diffusion layer.

7. The fuel cell unit as claimed in claim 6, wherein a plurality of branches of the flow channel of excess hydrogen gas and a plurality of branches of the flow channel of oxygen gas are interlaced disposed on the second catalyst layer.

8. A fuel cell system, comprising:
a hydrogen gas supply unit; and
a fuel cell unit, comprising:
a proton exchange membrane;
a first catalyst layer;
a second catalyst layer, wherein the second catalyst layer and the first catalyst layer are respectively disposed at both sides of the proton exchange membrane;
a first gas diffusion layer, disposed on the first catalyst layer;
a second gas diffusion layer, disposed on the second catalyst layer;
a flow channel of hydrogen gas, disposed on the first gas diffusion layer for guiding a hydrogen gas supplied by the hydrogen gas supply unit to the first gas diffusion layer; and
a flow channel of excess hydrogen gas, disposed on the second gas diffusion layer and communicated with the flow channel of hydrogen gas, wherein the hydrogen gas in the flow channel of excess hydrogen gas and an oxygen gas outside the flow channel of excess hydrogen gas are capable of mixing with each other in the second gas diffusion layer and contacting the second catalyst layer to generate a chemical combustion reaction.

9. The fuel cell system as claimed in claim 8, further comprising:
a flow channel of oxygen gas, disposed on the second gas diffusion layer for guiding the oxygen gas to the second gas diffusion layer, wherein the flow channel of oxygen gas and the flow channel of excess hydrogen gas are separated from each other, and the hydrogen gas in the flow channel of excess hydrogen gas and the oxygen gas in the flow channel of oxygen gas are capable of mixing with each other in the second gas diffusion layer.

10. The fuel cell system as claimed in claim 9, wherein a plurality of branches of the flow channel of excess hydrogen gas and a plurality of branches of the flow channel of oxygen gas are interlaced disposed on the second catalyst layer.
